(19) United States
(12) Patent Application Publication
(10) Pub. No.: US 2015/0073806 A1
(43) Pub. Date: Mar. 12, 2015

(54) Heirloom Article with Sound Recording and Playback Feature

(71) Applicant: Lance David Murray, Frankton (NZ)

(72) Inventor: Lance David MURRAY, Frankton (NZ)

(21) Appl. No.: 14/021,226

(22) Filed: Sep. 9, 2013

(51) Int. Cl. G10L 13/04; G06F 3/16

(52) U.S. Cl. CPC G10L 13/043; G06F 3/16
USPC 704/272

(57) ABSTRACT

An heirloom article including voice recording and playback features includes a data storage device with an optical data interface for transferring sound data to and from the flash memory module, and an inductive power receiver. The heirloom article is provided with a receiving space for receiving the data storage device. Within the heirloom article are provided an optical data interface configured to receive sound data from the data storage device, a sound playback device disposed within the heirloom article and connected to the optical data interface, and an inductive power supply element arranged to inductively provide power to the inductive power receiver of the data storage device. A vocal recording stored on the data storage device may be played back upon placement of the data storage device within the receiving space. The data storage device may be formed as a wearable object such as a pendant.

### FIELD OF THE INVENTION

The present invention relates to an audio recording and playback device, and more particularly an audio data storage device and recording and playback docking station which may be configured as an heirloom memory holder, such as a toy, figurine or stuffed figure keepsake in certain embodiments.

### BACKGROUND

Human children and adults alike have, throughout history, collected keepsake and heirloom memory items, in a great variety of forms. For example, Toy dolls and figurines have long been used, by children as well as adults, as objects of play, as well as object of affection. Among well known examples is a “teddy bear,” among many other forms of stuffed animals, which may become an object of sentimental attachment both in view of fondness for the stuffed animal itself and, often, in view of an emotional or familial bond with a person giving the stuffed animal as a gift. That is, for example, such a keepsake or heirloom item received by a child from a grandparent or other loved one may hold a particularly special place in the child's hear and memories. Of course, such attachments are not reserved for children and teddy bears, since adults may similarly develop or maintain such attachments to certain keepsake and heirloom memory items, including an certainly not limited to ones obtained in childhood.

Various articles that may be regarded as having some value as a keepsake or heirloom, have been provided with means for playing a prerecorded sound, to provide or enhance an interactive experience with, or simple enjoyment of, such articles. And, the addition of such a sound feature may increase the potential for a keepsake or heirloom value of such an article, especially if the sound may be a voice of a loved one, perhaps delivering a special and personal message.

It is desirable to further enhance a person's interaction with, and enjoyment of, such articles by providing a further emotionally fulfilling aspect wherein, as in the present invention, a wearable keepsake or heirloom element is provided in functional conjunction with such a collectible article, such that the owner may carry or wear the wearable keepsake or heirloom element, deriving positive emotional impact both from wearable keepsake or heirloom itself and the playback enabled by a companion keepsake or heirloom article.

### SUMMARY

One embodiment of the present invention can be characterized as a keepsake or heirloom article including voice recording and playback feature, comprising broadly a sound storage device configured as a wearable article, and an article configured as a “docking station” to receive the wearable sound storage device and to play back a sound recording stored by the sound storage device. The wearable sound storage device may be configured as a pendant necklace, bracelet, jewelry item or in another wearable or portably carryable form, and the “docking station” article may be of any of numerous different configurations including, but not limited to, a toy, doll, figurine or stuffed animal or doll (such as “plush” doll or figurine) or the like.

Considering by way of example a configuration embodied as a stuffed animal, a data storage device is provided comprising a waterproof flash memory module, an optical data interface for transferring sound data to and from the flash memory module, and an inductive power receiver. A stuffed animal is provided with a receiving space for receiving the data storage device, configured essentially as a “docking station” for the data storage device. Further disposed in the stuffed animal are an optical data interface configured to receive sound data from the data storage device, a sound playback device disposed within the stuffed animal and connected to the optical data interface, and an inductive power supply element arranged to inductively provide power to the inductive power receiver of the data storage device.

The data storage device may be further embodied as a wearable object, such as a necklace, pendant, bracelet, pin or the like. For example, a data storage device may be formed as a heart-shaped pendant, and the receiving space provided in a suitable location for the stuffed animal's “heart” such as within a figure's chest.

Additional embodiments of the data storage device and a sound playback device comprising an optical data interface configured to receive sound data from the data storage device and an inductive power supply element arranged to inductively provide power to the inductive power receiver of the data storage device may be provided apart from a stuffed animal and in conjunction with another toy or another type of device.

These and other features, aspects, and advantages of the present invention will become better understood with regard to the following description, appended claims, and accompanying drawings.

### BRIEF DESCRIPTION OF THE DRAWINGS

FIG. 1 is a perspective view of a keepsake article according to one embodiment of the present invention.

FIG. 2 is a block diagram of an audio processing arrangement according to one embodiment of the present invention.

FIG. 3 is a block diagram of a data storage device according to one embodiment of the present invention.

### DETAILED DESCRIPTION OF VARIOUS EMBODIMENTS

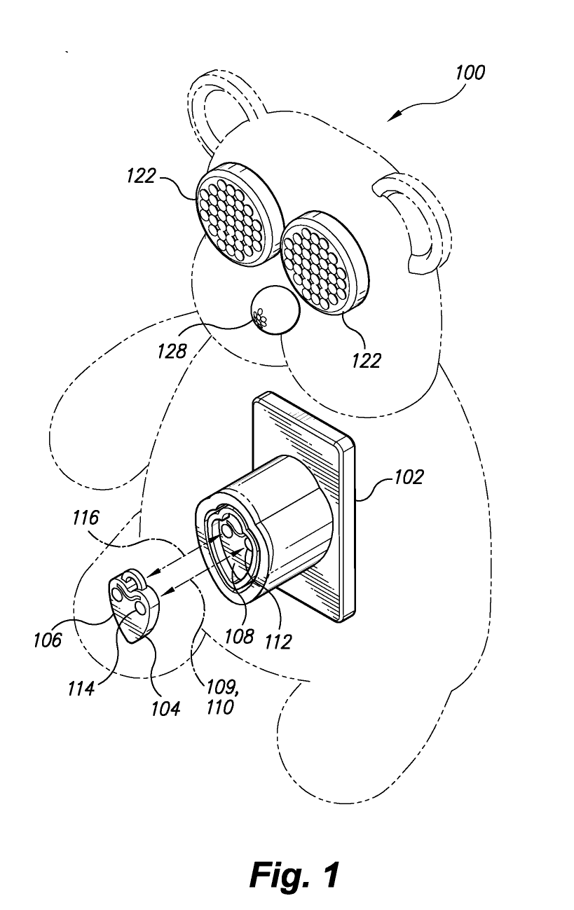

Referring to FIG. 1, an embodiment of the present invention is shown as a keepsake article 100, having an internally disposed audio processing arrangement 102 and an externally disposed and removable audio storage device 104. The audio storage device 104 is configured to store audio data, such as a digitally encoded sound recording, and to communicate wirelessly with the audio processing arrangement 102. The audio processing arrangement 102 is configured for playback of the audio data. More broadly stated, the present invention can be described as an audio storage device 104 and an audio processing arrangement 102 or docking station wherein the audio storage device 104 can be removably coupled to the audio processing arrangement 102 to play a recorded sound.

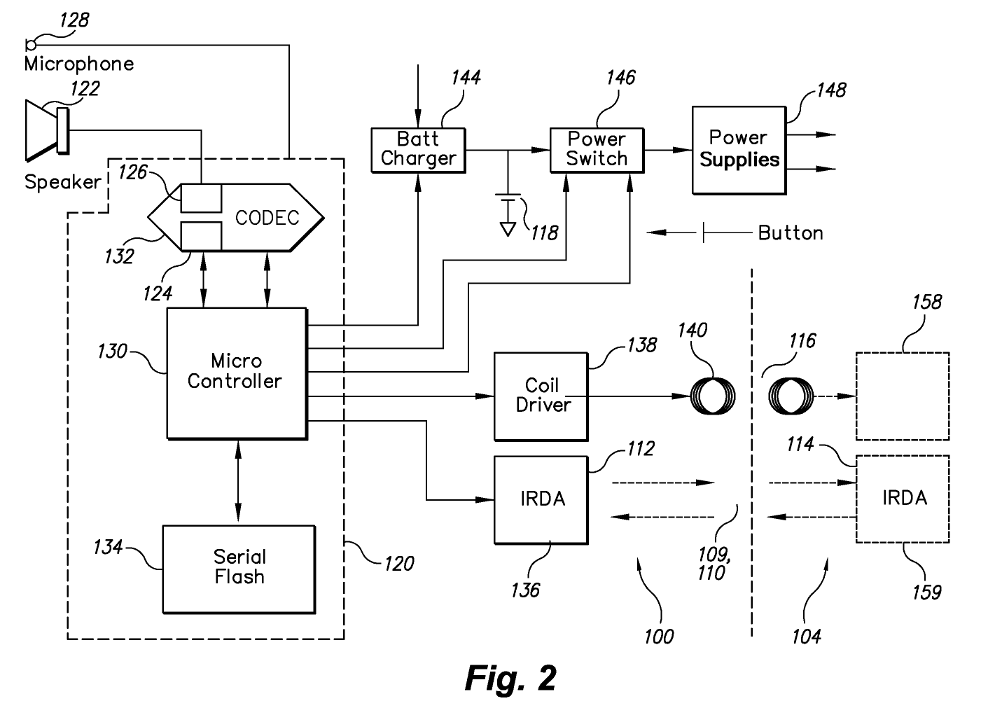

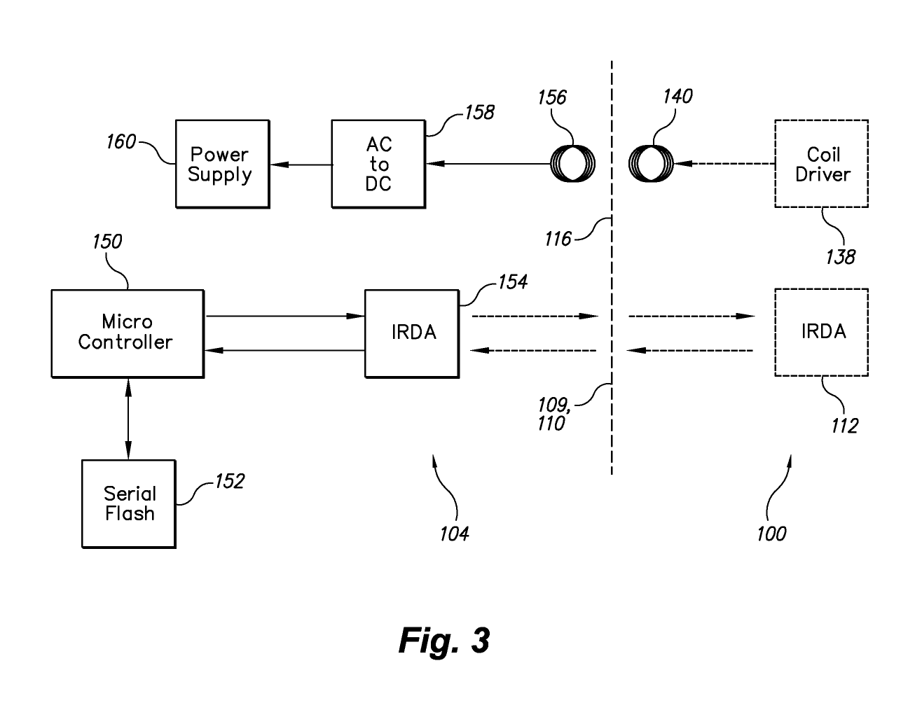

Considering the embodiment of FIG. 1 in greater detail, along with FIGS. 2 and 3, the removable audio storage device 104 can be provided in a decorative or wearable form, for example such as the heart-shaped pendant 106 shown in the drawing. A corresponding receptacle 108 is formed in the keepsake article 100, and for example when the keepsake article 100 is configured as a stuffed animal, the receptacle 108 may be formed in the body of the stuffed animal. Hence, the keepsake article 100 may be considered broadly speaking as a form of “docking station” for the removable audio storage device 104. The receptacle 108 is configured to receive the audio storage device 104 such that a wireless communication interface 109 between the audio storage device 104 and the audio processing arrangement 102 is enabled. In the illustrated embodiment, the wireless communication interface 109 is provided as an optical communication interface 110, comprising a first optical transmitter/receiver 112 disposed in the audio storage device 104, and a second optical transmitter/receiver 114 correspondingly disposed in the receptacle 108. Thus, digital audio data stored on the audio storage device 104 can be communicated to the audio processing arrangement 102 upon placement of the audio storage device 104 within the receptacle 108 or in such proximity to the receptacle 108 as to establish data communication via the wireless communication interface 109.

In addition to the wireless communication interface 109 between the audio storage device 104 and the audio processing arrangement 102, a wireless power interface 116 may be provided, whereby an electrical power supply is provided to one of the audio storage device 104 and the audio processing arrangement 102 wirelessly by the other. For example, an electrical power supply such as, but not limited to, a battery power supply 118, may be provided in the keepsake article 100, with the battery power supply 118 used in part to power the audio processing arrangement 102 and in part to power the wireless power interface 116 for providing an electrical power source to the audio storage device 104. Although, in certain embodiments, the electrical power supply could be provided in conjunction with the audio storage device 104 and the audio processing arrangement 102 powered by the wireless power interface 116, it can be recognized as advantageous in embodiments such as that illustrated that the audio storage device 104 be the device powered by the wireless power interface 116 in the interest of compactness and portability of the audio storage device 104.

The audio processing arrangement 102 includes an audio signal processing module 120 and at least one audio speaker 122. The audio signal processing module 120 is electrically connected to the second optical transmitter/receiver 114, and is configured to receive digital audio data received by the second optical transmitter/receiver 114 and convert the received digital audio data to a signal suitable for driving the at least one audio speaker 122. For example, the audio signal processing module 120 may include a digital-to-analog converter 124 to convert the digital audio data into an analog audio signal, and an amplifier 126 to amplify the analog audio signal suitably for driving the at least one audio speaker 122. In FIG. 1, a pair of audio speakers 122 is disposed within the keepsake article 100. When the keepsake article 100 is embodied as a stuffed animal, for example, placement of the speakers 122 within a head portion of the keepsake article 100 results in an effect wherein the keepsake article 100 can appear as “speaking ” Of course, the speakers 122 within the keepsake article 100 may be placed in other positions within the keepsake article 100, and may be replaced or supplemented by an interface for communication to an external speaker or headphone arrangement or the like.

In certain embodiments, the audio processing arrangement 102, may be further configured to receive an audio sound, convert the audio sound to digital audio data and communicate the digital audio data to the audio storage device 104 via the wireless communication interface 109 for storage. In such embodiments, at least one audio microphone 128 is connected to an audio signal processing module 120, and the audio signal processing module 120 is configured to convert an analog audio signal received from the microphone 128 into a digital audio data format. The audio signal processing module 120 is electrically connected to the second optical transmitter/receiver 114, and is configured to transmit the digital audio data to the audio storage device 104. In the illustrated embodiment, wherein the keepsake article 100 is configured as a stuffed animal, the microphone 128 is disposed in the head of the keepsake article 100, although of course, the microphone 128 may be alternatively disposed.

Turning to FIG. 2, one embodiment of an audio signal processing module 120 adapted for both digital sound recording and playback functions comprises a computer processing element such as a microcontroller 130 in conjunction with an audio/digital coding/encoding device (CODEC) 132, with both speakers 122 and microphone 128 connected to the CODEC 132 such that the microcontroller 130 and CODEC 132 are configured to perform both sound recording and playback functions. The CODEC 132 may integrate digital-to-analog converter 124 and amplifier 126, as well as an analog-to-digital converter supporting sound recording functions, into a single component, or alternatively these elements may be comprised of separate components or circuits. A computer program comprising computer program instructions may be stored in a memory of the microcontroller 130 or in an external memory 134 connected to the microcontroller 130 for configuration and operation of the microcontroller 130 to control audio recording and playback, as well as power management functions.

The microcontroller 130 is connected to the wireless communication interface 109, embodied in the illustrated embodiment as an IrDA (Infrared Data Association) compliant infrared interface circuit or device 136. The microcontroller 130 is further connected to a coil driver 138 which is in turn connected to a coil 140 forming a supply side of the wireless power interface 116. Additionally, the audio processing arrangement 102 may include an electrical power source such as rechargeable battery 142, as well as a battery charging module 144, power switch 146 and power supplies 148 configured for supply of necessary operating voltages for the microcontroller 130, CODEC 132, and interfaces 110 and 116.

The power switch 146 of course is provided to power the circuitry on and off, and may be provided within the keepsake article. For example, where the keepsake article 100 is configured as a stuffed animal or other doll figure, a pressure activated switch may be provided within the stuffed animal or other doll figure, such as an arm or leg, and may be activated by squeezing the extremity. The power switch 146 may be alternatively disposed, such as placed elsewhere within the keepsake article 100, and may be operated in another manner. For example, a simple toggle switch, slide switch or pushbutton may be provided in an easily accessed location (such as on a back side of the keepsake article 100). Additional switches may be provided for example to separately activate a record versus a playback mode, or a single switch may be provided and configured in conjunction with the computer program of the microcontroller 130 to activate different modes by, for example, recognizing different switching sequences of the power switch 146.

It is desirable for the audio signal processing module 120 to be configured for and capable of recording and playback of voice recordings, and as such it is desirable that a suitable audio bandwidth be supported, and that a suitable data format for digital audio storage and playback be employed. For example, a 16-bit digital resolution, and 10 k audio bandwidth are suitable, although persons skilled in the art will recognize that these figures are exemplary only, and that a different resolution and bandwidth may be employed suitably for a given desired audio playback.

Turning next to FIG. 3, one embodiment of the audio storage device 104 comprises a computer processing element such as a microcontroller 150 in conjunction with a memory device 152 for storage of the digital audio data. A computer program comprising computer program instructions may be stored in a memory of the microcontroller 150 or in an external memory connected to the microcontroller 150 for configuration and operation of the microcontroller 150 to control digital audio data transmit, receive and storage functions, as well as management functions relating to the wireless data and power interfaces 109, 116. The microcontroller 150 is connected to a receiving element 154 of the wireless communication interface 109, embodied in the illustrated embodiment as an IrDA (Infrared Data Association) compliant infrared interface circuit or device. An electrical power receiving element 155 of the wireless power interface 116 is embodied, in the illustrated embodiment, by a receiving coil 156 connected to an alternating current (AC) to direct current (DC) converter 158, further connected to a power supply 160 configured for supply of necessary operating voltages for the microcontroller 150, and electrical power receiving element 155.

It will be understood that the above-described embodiments of the invention are illustrative in nature, and that modifications thereof may occur to those skilled in the art. Accordingly, this invention is not to be regarded as limited to the embodiments disclosed herein, but is to be limited only as defined in the appended claims.

I claim:

1. A keepsake article including voice recording and playback feature, comprising:
a data storage device comprising a waterproof flash memory module, an optical data interface for transferring sound data to and from the flash memory module, and an inductive power receiver;
a docking station having a receiving space for receiving the data storage device;
an optical data interface configured to receive sound data from the data storage device;
a sound playback device disposed within the docking station and connected to the optical data interface; and
an inductive power supply element arranged to inductively provide power to the inductive power receiver of the data storage device.

2. The keepsake article of claim 1, wherein the sound recording device is a voice recorder.

3. The keepsake article of claim 2, wherein said voice recorder has a 10 KHz bandwidth and 16 bit resolution.

4. The keepsake article of claim 1, further comprising at least one audio speaker disposed within said docking station and electrically connected to said sound playback device.

5. The keepsake article of claim 1, further comprising a sound recording device disposed within said docking station and electrically connected to the optical data interface.

6. A voice recording and playback device, comprising:
a data storage device comprising a waterproof flash memory module, an optical data interface for transferring sound data to and from the flash memory module, and an inductive power receiver;
a docking station including a sound playback device comprising an optical data interface configured to receive sound data from the data storage device, and an inductive power supply element arranged to inductively provide power to the inductive power receiver of the data storage device;
wherein said data storage device is removably couplable with said sound playback device such that the optical data interface and inductive power receiver of said data storage device are in functional proximity to the optical data interface and inductive power supply of the sound playback device.

7. The voice recording and playback device of claim 6, wherein the sound recording device is a voice recorder.

8. The voice recording and playback device of claim 7, wherein said voice recorder has a 10 KHz bandwidth and 16 bit resolution.

9. The voice recording and playback device of claim 6, further comprising at least one audio speaker disposed within said docking station and electrically connected to said sound playback device.

10. The voice recording and playback device of claim 6, further comprising a sound recording device disposed within said docking station and electrically connected to the optical data interface.
